(19) United States
(12) Patent Application Publication
(10) Pub. No.: US 2012/0208894 A1
(43) Pub. Date: Aug. 16, 2012

(54) MULTI-PURPOSE HAND DISINFECTANT

(75) Inventors: Guenter Kampf, Hamburg (DE); Claudia James, Hamburg (DE); Sven Eggerstedt, Hamburg (DE); Marco Rudolf, Basel (CH)

(73) Assignee: BODE Chemie GmbH & Co. KG, Hamburg (DE)

(21) Appl. No.: 12/405,182

(22) Filed: Mar. 16, 2009

Related U.S. Application Data
(60) Provisional application No. 61/037,217, filed on Mar. 17, 2008.

(51) Int. Cl. A01N 31/02; A01P 1/00

(52) U.S. Cl. 514/724

(57) ABSTRACT

A multi-purpose hand disinfectant and in particular, a hand disinfectant which meets the FDA (Food and Drug Administration) requirements for use both as an antiseptic handwash or health-care personnel handwash drug product and as a surgical hand scrub drug product is described herein.

### PRIORITY

The instant application claims the benefit of U.S. Provisional Application No. 61/037,217, filed Mar. 17, 2008, the entire contents of which are hereby incorporated by reference herein.

### BACKGROUND OF THE INVENTION

1. Field of the Invention

The present invention relates generally to a multi-purpose hand disinfectant and in particular, a hand disinfectant which meets the FDA (Food and Drug Administration) requirements for use both as an antiseptic handwash or health-care personnel handwash drug product and as a surgical hand scrub drug product.

2. Discussion of Background Information

For hygienic hand disinfection (HHD) alcoholic gels and lotions which contain from about 60 to 63% v/v of ethanol and comprise further antimicrobial agents to increase their disinfectant effect are predominantly used in the U.S. The effect of these products is determined by an in-vitro time kill test and additionally in an FDA test which uses artificial contamination with Serratia marcescens (see FDA Tentative Final Monograph for Healthcare Antiseptic Drug Products (hereafter “TFM”), Effectiveness testing of an antiseptic handwash or health-care personnel handwash drug product. Federal Register 59 [116], Jun. 17, 1994, pp. 31444, 31445, 31448-31450, the entire disclosure whereof is expressly incorporated by reference herein).

To be suitable for surgical hand disinfection (SHD) a disinfectant is required to exhibit not only an immediate effect (as required for a product for HHD) but also a persistent and cumulative effect. The corresponding requirements are set forth in FDA TFM, Federal Register 59 [116], Jun. 17, 1994: pp. 31444-31448, Effectiveness testing of a surgical hand scrub drug product, the entire disclosure whereof is expressly incorporated by reference herein. To be able to meet these stringent requirements corresponding products usually comprise one or more alcohols in combination with remanent antimicrobial agents (i.e., agents which stay on the skin) such as chlorhexidine.

The existence of different types of hand disinfectants for HHD and SHD, i.e., hand disinfectants with different property profiles, is not only inconvenient for individuals who need a product only for HHD or only for SHD (because they may inadvertently purchase the wrong product), but may even be dangerous for example, in a hospital setting where the inadvertent use of an HHD product by an individual involved in surgery may have severe, if not fatal, consequences.

### SUMMARY OF THE INVENTION

The present invention provides a method of eliminating the possibility of an individual inadvertently purchasing and/or using the wrong product for hand disinfection, i.e., inadvertently purchasing and/or using a product for hygienic hand disinfection instead of a surgical hand scrub and vice versa. The method comprises providing and/or offering for sale a composition which meets FDA requirements for use both as an antiseptic handwash or health-care personnel handwash drug product and as a surgical hand scrub drug product.

In one aspect of the method, the risk of an individual (e.g., an individual involved in surgery) inadvertently using as a surgical hand scrub a product which meets FDA requirements for an antiseptic handwash or health-care personnel handwash drug product but does not meet FDA requirements for a surgical hand scrub drug product may be eliminated.

The present invention also provides a method of facilitating the purchasing process of hand disinfectants by a healthcare provider. The method comprises providing and/or offering for sale a composition which meets FDA requirements for use both as an antiseptic handwash or health-care personnel handwash drug product and as a surgical hand scrub drug product.

In one aspect of the above methods, the composition may comprise at least about 50% by weight of one or more C₁₋₆ alkanols, based on the total weight of the composition. For example, the composition may comprise at least about 70% by weight of ethanol.

In another aspect of the above methods, the composition may comprise one or more C₁₋₆ alkanols as substantially the only antimicrobial substance(s). For example, the composition may comprise ethanol as substantially the only antimicrobial substance.

In yet another aspect of the above methods, the composition may be substantially free of preservatives.

The present invention also provides antiseptic compositions for use in the methods which are set forth above. Specifically, the present invention provides, inter alia, an antiseptic composition which meets FDA requirements for use both as an antiseptic handwash or health-care personnel handwash drug product and as a surgical hand scrub drug product and is associated and/or offered for sale with an indication to the effect that the composition is suitable for use as a surgical hand scrub as well as for hygienic hand disinfection (e.g., suitable as a hand disinfectant for everyday use, an antiseptic handwash and/or a health-care personnel handwash).

In one aspect, the composition may provide a reduction of the number of bacteria (e.g., Serratia marcescens) of at least about 2.0 log₁₀ within five minutes after the first wash when the composition is tested as an antiseptic handwash or health-care personnel handwash drug product according to FDA TFM in an amount of not more than about 2.4 ml and/or the composition may provide a reduction of the number of bacteria of at least about 1.5 log₁₀ within one minute on the first day when the composition is tested as a surgical hand scrub drug product according to FDA TFM in an amount of not more than about 10 ml.

In another aspect, the composition may comprise at least about 50% by weight of one or more C₁₋₆ alkanols, based on the total weight of the composition. For example, the composition may comprise at least about 70% by weight of ethanol.

In yet another aspect, the composition may comprise one or more C₁₋₆ alkanols as substantially the only antimicrobial substance(s) present therein. For example, the composition may comprise ethanol as substantially the only antimicrobial substance present therein.

In a still further aspect, the composition may be substantially free of preservatives and/or the composition may be substantially free of inorganic acids or organic acids (in particular, non-polymeric organic acids).

The present invention also provides a composition which meets FDA requirements for both a surgical hand scrub drug product and an antiseptic handwash or health-care personnel handwash drug product and comprises, based on the total weight of the composition:
from about 50% to about 99% by weight of one or more C₁₋₆ alkanols;
from about 1% to about 50% by weight of water;
from about 0.2% to about 10% by weight of one or more skin care components; and
from about 0.1% to about 3% by weight of one or more thickeners.

In one aspect, the composition may comprise
from about 70% to about 90% by weight of one or more C₁₋₆ alkanols;
from about 5% to about 20% by weight of water;
from about 1% to about 7% by weight of one or more skin care components; and
from about 0.15% to about 2% by weight of one or more thickeners.

In another aspect, the composition may comprise
from about 80% to about 90% by weight of one or more C₁₋₆ alkanols;
from about 8% to about 15% by weight of water;
from about 2% to about 5% by weight of one or more skin care components; and
from about 0.2% to about 1% of one or more thickeners.

In another aspect, the composition may comprise
from about 82% to about 87% by weight of one or more C₁₋₆ alkanols;
from about 9% to about 12% by weight of water;
from about 3% to about 4.5% by weight of one or more skin care components; and
from about 0.25% to about 0.5% by weight of one or more thickeners.

In another aspect, the composition may comprise:
from about 84% to about 86% by weight of one or more C₁₋₆ alkanols;
from about 10% to about 11% by weight of water;
from about 3.5% to about 4% by weight of one or more skin care components; and
from about 0.3% to about 0.4% by weight of one or more thickeners.

In yet another aspect of the above composition, the one or more C₁₋₆ alkanols may comprise ethanol.

In another aspect, the one or more skin care components of the above composition may comprise at least one oil component such as, e.g., a silicone oil and/or an aliphatic hydrocarbon (paraffin) oil. For example, the one or more skin care components may comprise cyclomethicone and/or isohexadecane.

In a still further aspect, the one or more skin care components may comprise one or more of glycerin, bisabolol and myristyl alcohol.

In another aspect of the above composition, the one or more thickeners may comprise at least one of an acrylic polymer, a cellulosic polymer, a starch-based polymer and polyvinylpyrrolidone. For example, the one or more thickeners may comprise acrylates/C10-30 alkyl acrylate crosspolymer and polyvinylpyrrolidone.

In yet another aspect, the composition may be substantially free of any antimicrobial substance which is different from a C₁₋₆ alkanol and/or the composition may be substantially free of preservatives and/or the composition may be substantially free of an inorganic or organic acid (in particular, a non-polymeric organic acid).

In another aspect, the composition may provide a reduction of the number of bacteria (e.g., Serratia marcescens) of at least about 2.0 log₁₀ within five minutes after the first wash when the composition is tested as an antiseptic handwash or health-care personnel handwash drug product according to FDA TFM in an amount of not more than about 2.4 ml and/or the composition may provide a reduction of the number of bacteria of at least about 1.5 log₁₀ within one minute on the first day when the composition is tested as a surgical hand scrub drug product according to FDA TFM in an amount of not more than about 10 ml.

The present invention also provides an antiseptic composition which meets the FDA requirements for both a surgical hand scrub drug product and an antiseptic handwash or health-care personnel handwash drug product and comprises, based on the total weight of the composition:
from about 50% to about 99% by weight of one or more C₁₋₆ alkanols;
from about 1% to about 50% by weight of water; and
from about 0.1% to about 8% by weight of one or more skin care components.

In one aspect, the composition may comprise:
from about 60% to about 95% by weight of one or more C₁₋₆ alkanols;
from about 5% to about 30% by weight of water; and
from about 0.2% to about 4% by weight of one or more skin care components.

In another aspect, the composition may comprise:
from about 70% to about 90% by weight of one or more C₁₋₆ alkanols;
from about 10% to about 25% by weight of water; and
from about 0.3% to about 2% by weight of one or more skin care components.

In another aspect, the composition may comprise:
from about 75% to about 85% by weight of one or more C₁₋₆ alkanols;
from about 15% to about 20% by weight of water; and
from about 0.4% to about 1% by weight of one or more skin care components.

In yet another aspect of the composition, the one or more C₁₋₆ alkanols may comprise ethanol and/or the one or more skin care components may comprise at least one oil component, for example, an aliphatic hydrocarbon oil such as, e.g., isohexadecane.

In a still further aspect of the composition, the one or more skin care components may comprise a wool wax component such as, e.g., lanolin alcohol.

In another aspect of the above composition, the one or more skin care components may comprise one or more of pyrrolidone-2-carboxylic acid and a cosmetically acceptable salt thereof, myristyl alcohol, and ethylhexyl ethylhexanoate.

In yet another aspect, the composition may be substantially free of any antimicrobial substance which is different from ethanol and/or may be substantially free of preservatives.

In another aspect, the composition may provide a reduction of the number of bacteria (e.g., Serratia marcescens) of at least about 2.0 log₁₀ within five minutes after the first wash when the composition is tested as an antiseptic handwash or health-care personnel handwash drug product according to FDA TFM in an amount of not more than about 2.4 ml and/or the composition may provide a reduction of the number of bacteria of at least about 1.5 log₁₀ within one minute on the first day when the composition is tested as a surgical hand scrub drug product according to FDA TFM in an amount of not more than about 10 ml.

The present invention also provides an antiseptic composition which meets the FDA requirements for both a surgical hand scrub drug product and an antiseptic handwash or health-care personnel handwash drug product and comprises at least about 70% by weight of ethanol, based on the total weight of the composition, and is substantially free of any inorganic acids or organic acids (in particular, non-polymeric organic acids) and any antimicrobial substances which are different from ethanol.

In one aspect, the composition may comprise at least about 80% by weight of ethanol.

In another aspect, the composition may be substantially free of preservatives.

In yet another aspect, the composition may provide a reduction of the number of bacteria (e.g., Serratia marcescens) of at least about 2.0 log₁₀ within five minutes after the first wash when the composition is tested as an antiseptic handwash or health-care personnel handwash drug product according to FDA TFM in an amount of not more than about 2.4 ml and/or the composition may provide a reduction of the number of bacteria of at least about 1.5 log₁₀ within one minute on the first day when the composition is tested as a surgical hand scrub drug product according to FDA TFM in an amount of not more than about 10 ml.

### DETAILED DESCRIPTION OF THE PRESENT INVENTION

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

As set forth above, the present invention provides a method of eliminating the possibility of an individual inadvertently purchasing and/or using the wrong product for hand disinfection, i.e., purchasing and/or using a product for HHD instead of a product for SHD or purchasing and/or using a product for SHD instead of a product for HHD. The method comprises providing and/or offering for sale a composition which meets the corresponding FDA requirements for use both as an antiseptic handwash or health-care personnel handwash drug product and as a surgical hand scrub drug product.

Compositions for use in this method will usually comprise at least about 50% by weight, e.g., at least about 60%, at least about 65%, at least about 70%, at least about 75%, at least about 80% by weight, or at least about 85% by weight of one or more C₁₋₆ alkanols, although they will usually comprise not more than about 99.5%, e.g., not more than about 99% by weight, not more than about 98% by weight, not more than about 95% by weight, or not more than about 90% by weight, of the one or more C₁₋₆ alkanols, based on the total weight of the composition.

Non-limiting examples of C₁₋₆ alkanols for use in the present invention include C₁₋₄ alkanols such as methanol, ethanol, 1-propanol, 2-propanol and 1-butanol. Ethanol, 1-propanol and 2-propanol are preferred and ethanol is particularly preferred. For example, ethanol may account for at least about 50% by weight, e.g., at least about 75%, at least about 90%, or even about 100% by weight of the one or more C₁₋₆ alkanols which are present in a composition of the present invention. The number of C₁₋₆ alkanols that may be present in a composition of the present invention is not limited. For example, a mixture of two, three or four different C₁₋₆ alkanols may be used.

The one or more C₁₋₆ alkanols will often be substantially the only antimicrobial substances which are present in a composition of the present invention, i.e., other antimicrobial substances will be present not at all or only in negligible (total) amounts (e.g., in amounts of less than about 0.05%, less than about 0.01%, or even less than about 0.001% by weight). In this regard, it is to be appreciated that whenever in the present specification and the appended claims it is stated that the composition is “substantially free” of a component/agent, this is meant to indicate that the component/agent is present either not at all or only in negligible (total) amounts such as, e.g., in amounts of less than about 0.05%, less than about 0.01%, or even less than about 0.001% by weight, based on the total weight of the composition.

If one or more antimicrobial substances which are different from a C₁₋₆ alkanol are present in the compositions of the present invention, either by themselves or in combination with one or more C₁₋₆ alkanols, these antimicrobial substances can be selected from any of the antimicrobial (antiseptic) substances which are suitable for coming into contact with human skin. Non-limiting examples of such antimicrobial substances include those which are conventionally used for hand (skin) disinfection, for example, chlorhexidine and salts thereof (e.g., chlorhexidine digluconate), quaternary ammonium compounds such as, e.g., dimethylethylhexadecylammonium methosulfate, undecylene amidopropyl trimonium methosulfate, didecyldimethylammonium chloride and benzalkonium chloride, phenols such as, e.g., phenol, bisphenol, 2-phenylphenol, 2-benzyl-4-chlorophenol, 4-chloro-3,5-xylenol and 5-chloro-2-(2,4-dichlorophenoxy)phenol, parabens, hydantoins and derivatives thereof, phenoxyethanol, inorganic and organic acids such as, e.g., undecylenic acid, methylchloroisothiazolinone, methylisothiazolinone, imidazolidinyl urea, benzethoniumchloride, methylbenzethonium chloride, polyhexanide, polyhexamethylene biguanide, bisbiguanide, triclosan, PVP-iodine, octenidine dihydrochloride, 3-(4-chlorophenoxy)-1,2-propanediol, hexetidine, 2-bromo-2-nitropropane-1,3-diol, cetylpyridinium chloride and/or sodium hydroxymethylglycinate.

Apart from the one or more antimicrobial agents, the compositions of the present invention may contain one or more additional components as long as these components do not have a (significant) adverse effect on the disinfecting (antimicrobial) properties of the compositions. Non-limiting examples of such components include solvents such as, e.g., water, glycols, ketones and esters, oils, skin care agents (including moisturizers, humectants, emollients, skin conditioning agents, and skin protectants), antioxidants, thickeners, stabilizers, emulsifiers, surfactants, pH adjusters, neutralizing agents, preservatives, dyestuffs, and fragrances/perfumes. The additional components are usually present in a total amount of not more than about 20%, e.g., not more than about 15%, or not more than about 10%, based on the total weight of the composition.

Non-limiting examples of skin care agents for use in the compositions of the present invention include triols such as, e.g., glycerin, and 1,2,6-hexanetriol, glycols such as, e.g., 1,2-propyleneglycol, dipropyleneglycol, triethyleneglycol, and hexylene glycol, dexpanthenol, isopropyl myristate, ethyl myristate, isopropyl palmitate, cetyl palmitate, isopropyl lactate, 2-ethylhexyl 2-ethylhexanoate, oleyl lactate, oleyl oleate, decyl oleate, bees wax, jojoba oil, petrolatum, glycerin triacetate, bisabolol, tetradecanol, hexadecanol, octadecanol, hexadecane-1,2-diol, pyrrolidonecarboxylic acid and salts thereof, urea, sorbitol, lanolin, wool wax alcohols such as, e.g., cholesterol, dihydrocholesterol, 7-oxocholesterol, cholestan-3,5,6-triol, lanosterin, and dihydrolanosterin, diisopropyl sebacate, hyaluronic acid, squalan, and chamomile extract.

Further non-limiting examples of skin care components for use in the compositions of the present invention include oil components, for example, silicone oils such as, e.g., cyclomethicone and dimethicone, paraffin oils such as, e.g., isohexadecane (isocetane, 2,2,4,4,6,8,8-heptamethylnonane), coconut oil, avocado oil, linseed oil, olive oil, evening primrose oil, wheat germ oil, palm kernel oil, almond oil, castor oil, hydrogenated castor oil, rice bran oil, sesame oil and peanut oil.

Non-limiting examples of thickeners for use in the compositions of the present invention include polyvinylpyrrolidone, acrylic polymers such as, e.g., acrylates/C10-30 alkyl acrylate crosspolymer, ammonium acryloyldimethyltaurate/vinylpyrrolidone copolymer, cellulosic polymers such as, e.g., hydroxyethylcellulose, hydroxypropyl cellulose, methylcellulose, and carboxyethylcellulose, and starch-based thickeners.

Non-limiting examples of antioxidants for use in the compositions of the present invention include ubiquinones such as, e.g., coenzyme Q10, plastoquinones, amino acids and derivatives thereof, imidazoles, carotenes, carotenoids, ascorbic acid and derivatives thereof, and tocopherol and derivatives thereof.

When tested as an antiseptic handwash or health-care personnel handwash drug product according to FDA TFM in an amount of not more than about 2.4 ml the compositions of the present invention preferably provide a reduction of the number of bacteria such as, e.g., Serratia marcescens of at least about 2.0 log₁₀, e.g., at least about 2.1 log₁₀, at least about 2.3 log₁₀, at least about 2.5 log₁₀, at least about 2.6 log₁₀, at least about 2.7 log₁₀, or at least about 2.75 log₁₀ within five minutes after the first wash.

Also preferably, when tested as a surgical hand scrub drug product according to FDA TFM in an amount of not more than about 10 ml (e.g., not more than about 8 ml, or not more than about 6 ml), the compositions of the present invention provide a reduction of the number of bacteria of at least about 1.5 log₁₀, e.g., at least about 2.0 log 10, at least about 2.3 log 10, at least about 2.5 log₁₀, at least about 2.7 log 10, or at least about 2.9 log₁₀ within one minute on the first day and/or they provide a reduction of the number of bacteria of at least about 2.2 log₁₀, e.g., at least about 2.4 log 10, at least about 2.6 log 10, at least about 2.8 log₁₀, at least about 2.9 log 10, or at least about 2.95 log₁₀ within one minute on the second day and/or they provide a reduction of the number of bacteria of at least about 3.0 log₁₀, e.g., at least about 3.1 log 10, at least about 3.2 log 10, at least about 3.3 log₁₀, or at least about 3.4 log₁₀ within one minute on the fifth day.

Also preferably, the compositions of the present invention, when tested in the FDA TFM Time Kill Study, reduce the number of each of the following pathogens within 15 seconds by at least about 5.3 log₁₀: Candida albicans, Enterococcus faecalis, Escherichia coli, Haemophilus influenca, Klebsiella pneumoniae, Proteus mirabilis, Pseudomonas aeruginosa, Salmonella enteridis, Serratia marcescens, Staphylococcus aureus, Staphylococcus epidermis, and Streptococcus pyrogenes. More preferably, the compositions of the present invention show one or more (and in particular, all) of the following log₁₀ reductions in the FDA TFM Time Kill Study:

| | Reduction in 15 seconds |
|---|---|
| Noscomial Pathogen | (log₁₀) |
| Candida albicans, ATCC 10231 | >5.8 |
| Clostridium difficile, ATCC 9689 | >5.3 |
| Enterococcus faecalis, ATCC 29212 | >7.0 |
| Enterococcus faecalis, VRE, Clinical isolate | >7.1 |
| Escherichia coli, ATCC 11229 | >6.6 |
| Haemophilus influenzae, ATCC 19418 | >5.8 |
| Klebsiella pneumoniae, ATCC 11296 | >6.5 |
| Proteus mirabilis, ATCC 7002 | >6.7 |
| Pseudomonas aeruginosa, ATCC 15442 | >6.5 |
| Salmonella enteritidis, ATCC 13076 | >6.7 |
| Serratia marescens, ATCC 14756 | >6.8 |
| Staphylococcus aureus, ATCC 6538 | >6.2 |
| Staphylococcus aureus MRSA, ATCC 33591 | >6.6 |
| Staphylococcus epidermis, Clinical isolate | >6.6 |
| Streptococcus pneumoniae, ATCC 6304 | >5.3 |
| Streptococcus pyogenes, ATCC 19615 | >6.1 |

The compositions of the present invention may be present in various forms such as, e.g., liquids (e.g., lotions), gels, and foams. Of course, they may also be present in and/or on a carrier such as, e.g., in the form of (impregnated) cloths (e.g., made of non-wovens), tissues, towelettes, etc. Of course, if a composition is present in the form of a foam, the volume which is needed to achieve the required antiseptic effect will be higher than in the case of an unfoamed composition such as, e.g., a liquid or a gel. Also, the amount of composition which is present in and/or on a carrier per unit of carrier (e.g., towelette etc.) should be at least the amount which would be required for the required antiseptic effect if the composition were present as such, i.e., without carrier.

### EXAMPLES

Several exemplary and non-limiting compositions according to the present invention are set forth below.

Composition A (% by weight)

| | |
|---|---|
| Ethanol | 85.00 |
| Water | 10.14 |
| Cyclomethicone | 1.20 |
| Isohexadecane | 0.55 |
| Myristyl Alcohol | 0.55 |
| Glycerin | 1.20 |
| Bisabolol | 0.01 |
| Tetrahydroxypropyl Ethylenediamine | 0.80 |
| Acrylates/C10-30 Alkyl Acrylate Crosspolymer | 0.40 |
| Polyvinylpyrrolidone | 0.05 |

Composition B (% by weight)

| | |
|---|---|
| Ethanol | 85.00 |
| Water | 10.55 |
| Cyclomethicone | 1.70 |
| Isohexadecane | 0.20 |
| Myristyl Alcohol | 0.80 |
| Glycerin | 0.90 |
| Bisabolol | 0.05 |
| Tetrahydroxypropyl Ethylenediamine | 0.50 |
| Acrylates/C10-30 Alkyl Acrylate Crosspolymer | 0.25 |
| Polyvinylpyrrolidone | 0.05 |

Composition C (% by weight)

| | |
|---|---|
| Ethanol | 85.00 |
| Water | 10.44 |
| Cyclomethicone | 2.00 |
| Isohexadecane | 0.36 |
| Myristyl Alcohol | 0.18 |
| Glycerin | 1.00 |
| Bisabolol | 0.02 |
| Tetrahydroxypropyl Ethylenediamine | 0.60 |
| Acrylates/C10-30 Alkyl Acrylate Crosspolymer | 0.30 |
| Polyvinylpyrrolidone | 0.10 |

Composition D (% by weight)

| | |
|---|---|
| Ethanol | 85.00 |
| Water | 10.08 |
| Cyclomethicone | 2.50 |
| Isohexadecane | 0.48 |
| Myristyl Alcohol | 0.48 |
| Glycerin | 0.50 |
| Bisabolol | 0.03 |
| Tetrahydroxypropyl Ethylenediamine | 0.54 |
| Acrylates/C10-30 Alkyl Acrylate Crosspolymer | 0.27 |
| Polyvinylpyrrolidone | 0.12 |

Composition E (% by weight)

| | |
|---|---|
| Ethanol | 85.00 |
| Water | 10.00 |
| Cyclomethicone | 2.70 |
| Isohexadecane | 0.26 |
| Myristyl Alcohol | 0.40 |
| Glycerin | 0.50 |
| Bisabolol | 0.02 |
| Tetrahydroxypropyl Ethylenediamine | 0.72 |
| Acrylates/C10-30 Alkyl Acrylate Crosspolymer | 0.36 |
| Polyvinylpyrrolidone | 0.04 |

Composition F (% by weight)

| | |
|---|---|
| Ethanol | 85.00 |
| n-Propanol | 2.50 |
| Water | 8.20 |
| Cyclomethicone | 1.50 |
| Hydrogenated Castor Oil | 0.20 |
| Isopropyl Myristate | 0.80 |
| Glycerin | 0.55 |
| Dexpanthenol | 0.20 |
| Tetrahydroxypropyl Ethylenediamine | 0.70 |
| Carbomer | 0.35 |

Composition G (% by weight)

| | |
|---|---|
| Ethanol | 85.00 |
| Water | 8.30 |
| Cyclomethicone | 1.25 |
| 1,2-Propylene Glycol | 2.50 |
| Isohexadecane | 0.45 |
| Cetyl palmitate | 0.30 |
| Glycerin | 0.70 |
| Phenoxyethanol | 0.50 |
| Tetrahydroxypropyl Ethylenediamine | 0.75 |
| Acrylates/C10-30 Alkyl Acrylate Crosspolymer | 0.35 |

Composition H (% by weight)

| | |
|---|---|
| Ethanol | 80.00 |
| Water | 18.98 |
| Isohexadecane | 0.25 |
| Lanolin Alcohol | 0.02 |
| Ethylhexyl Ethylhexanoate | 0.10 |
| Myristyl Alcohol | 0.25 |
| Pyrrolidonecarboxylic Acid | 0.15 |
| Sodium Pyrrolidonecarboxylic Acid | 0.20 |
| Fragrance | 0.05 |

Composition I (% by weight)

| | |
|---|---|
| Ethanol | 80.00 |
| Water | 19.56 |
| Isohexadecane | 0.10 |
| Lanolin Alcohol | 0.04 |
| Ethylhexyl Ethylhexanoate | 0.05 |
| Myristyl Alcohol | 0.15 |
| Pyrrolidonecarboxylic Acid | 0.02 |
| Sodium Pyrrolidonecarboxylic Acid | 0.05 |
| Fragrance | 0.03 |

Composition J (% by weight)

| | |
|---|---|
| Ethanol | 80.00 |
| Water | 19.27 |
| Isohexadecane | 0.20 |
| Lanolin Alcohol | 0.05 |
| Ethylhexyl Ethylhexanoate | 0.20 |
| Myristyl Alcohol | 0.10 |
| Pyrrolidonecarboxylic Acid | 0.05 |
| Sodium Pyrrolidonecarboxylic Acid | 0.10 |
| Fragrance | 0.03 |

Composition K (% by weight)

| | |
|---|---|
| Ethanol | 80.00 |
| Water | 19.11 |
| Isohexadecane | 0.10 |
| Lanolin Alcohol | 0.10 |
| Ethylhexyl Ethylhexanoate | 0.15 |
| Myristyl Alcohol | 0.25 |
| Pyrrolidonecarboxylic Acid | 0.08 |
| Sodium Pyrrolidonecarboxylic Acid | 0.15 |
| Fragrance | 0.06 |

Composition L (% by weight)

| | |
|---|---|
| Ethanol | 80.00 |
| Water | 18.06 |
| Isohexadecane | 0.25 |
| Lanolin Alcohol | 0.05 |
| Ethylhexyl Ethylhexanoate | 0.25 |
| Myristyl Alcohol | 0.40 |
| Pyrrolidonecarboxylic Acid | 0.05 |
| Sodium Pyrrolidonecarboxylic Acid | 0.10 |
| Lactic acid | 0.30 |
| Phenoxyethanol | 0.50 |
| Fragrance | 0.04 |

Composition M (% by weight)

| | |
|---|---|
| Ethanol | 80.00 |
| Water | 18.17 |
| Isohexadecane | 0.30 |
| Lanolin Alcohol | 0.10 |
| Ethylhexyl Ethylhexanoate | 0.40 |
| Myristyl Alcohol | 0.50 |
| Pyrrolidonecarboxylic Acid | 0.15 |
| Sodium Pyrrolidonecarboxylic Acid | 0.30 |
| Fragrance | 0.08 |

Composition N (% by weight)

| | |
|---|---|
| Ethanol | 80.00 |
| Isopropanol | 4.00 |
| Water | 15.08 |
| Isohexadecane | 0.30 |
| Lanolin Alcohol | 0.01 |
| Ethylhexyl Ethylhexanoate | 0.05 |
| Myristyl Alcohol | 0.30 |
| Pyrrolidonecarboxylic Acid | 0.07 |
| Sodium Pyrrolidonecarboxylic Acid | 0.14 |
| Fragrance | 0.05 |

Composition O (% by weight)

| | |
|---|---|
| Ethanol | 80.00 |
| n-Propanol | 4.00 |
| Water | 15.21 |
| Isohexadecane | 0.20 |
| Lanolin Alcohol | 0.02 |
| Ethylhexyl Ethylhexanoate | 0.05 |
| Myristyl Alcohol | 0.35 |
| Pyrrolidonecarboxylic Acid | 0.04 |
| Sodium Pyrrolidonecarboxylic Acid | 0.09 |
| Fragrance | 0.04 |

Composition P (% by weight)

| | |
|---|---|
| Ethanol | 80.00 |
| Water | 18.97 |
| Glycerin | 0.40 |
| Isopropyl Myristate | 0.20 |
| Dexpanthenol | 0.25 |
| Octyldodecanol | 0.15 |
| Fragrance | 0.03 |

Although the present invention has been described in considerable detail with regard to certain versions thereof, other versions are possible, and alterations, permutations, and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show embodiments of the present invention in more detail than is necessary for the fundamental understanding of the present invention, the description making apparent to those skilled in the art how the several forms of the present invention may be embodied in practice.

1-16. (canceled)

17. An antiseptic composition, wherein the composition meets FDA requirements for both a surgical hand scrub drug product and an antiseptic handwash or health-care personnel handwash drug product and comprises, based on a total weight of the composition:
from about 50% to about 99% by weight of one or more C₁₋₆ alkanols;
from about 1% to about 50% by weight of water;
from about 0.2% to about 10% by weight of one or more skin care components selected from the group consisting of cyclomethicone and isohexadecane; and
from about 0.1% to about 3% by weight of one or more thickeners selected from the group consisting of an acrylic polymer, a cellulosic polymer, a starch-based polymer polyvinylpyrrolidone, and an acrylate/C10-30 alkyl acrylate crosspolymer.

18. The composition of claim 17, wherein the composition comprises:
from about 70% to about 90% by weight of one or more C₁₋₆ alkanols;
from about 5% to about 20% by weight of water;
from about 1% to about 7% by weight of one or more skin care components; and
from about 0.15% to about 2% by weight of one or more thickeners.

19. The composition of claim 17, wherein the composition comprises:
from about 80% to about 90% by weight of one or more C₁₋₆ alkanols;
from about 8% to about 15% by weight of water;
from about 2% to about 5% by weight of one or more skin care components; and
from about 0.2% to about 1% of one or more thickeners.

20. The composition of claim 17, wherein the composition comprises:
from about 82% to about 87% by weight of one or more C₁₋₆ alkanols;
from about 9% to about 12% by weight of water;
from about 3% to about 4.5% by weight of one or more skin care components; and
from about 0.25% to about 0.5% by weight of one or more thickeners.

21. The composition of claim 17, wherein the composition comprises:
from about 84% to about 86% by weight of one or more C₁₋₆ alkanols;
from about 10% to about 11% by weight of water;
from about 3.5% to about 4% by weight of one or more skin care components; and
from about 0.30% to about 0.4% by weight of one or more thickeners.

22. The composition of claim 17, wherein the one or more C₁₋₆ alkanols comprise ethanol.

23. The composition of claim 17, wherein the skin care components further comprise at least one of a wool wax component, lanolin alcohol, a silicone oil and an aliphatic hydrocarbon oil.

24. (canceled)

25. The composition of claim 17, wherein the skin care components further comprise at least one of a glycerin, bisabolol, myristyl alcohol, pyrrolidone-2-carboxylic acid and a cosmetically acceptable salt thereof, and ethylhexyl ethylhexanoate.

26. (canceled)

27. (canceled)

28. The composition of claim 17, wherein the composition is substantially free of any antimicrobial substance which is different from a C₁₋₆ alkanol.

29. The composition of claim 17, wherein the composition is substantially free of preservatives.

30. The composition of claim 17, wherein the composition is substantially free of an inorganic or organic acid.

31. The composition of claim 17, wherein the composition, when tested as an antiseptic handwash or health-care personnel handwash drug product according to FDA TFM in an amount of not more than about 2.4 ml, provides a reduction of a number of bacteria of at least about 2.0 log₁₀ within five minutes after a first wash.

32. The composition of claim 17, wherein the composition, when tested as a surgical hand scrub drug product according to FDA TFM in an amount of not more than about 10 ml, provides a reduction of a number of bacteria of at least about 1.5 log₁₀ within one minute on a first day.

33-51. (canceled)
